(19) United States
(12) Patent Application Publication
(10) Pub. No.: US 2008/0052424 A1
(43) Pub. Date: Feb. 28, 2008

(54) Data access system, data access apparatus, data access integrated circuit, and data access method

(76) Inventors: Koji Sameshima, Osaka (JP); Takahiro Nakamachi, Shiga (JP); Kouichi Kanda, Kyoto (JP)

Correspondence Address: MCDERMOTT WILL & EMERY LLP, 600 13TH STREET, NW, WASHINGTON, DC, 20005-3096, US

(21) Appl. No.: 11/822,541

(22) Filed: Jul. 6, 2007

(30) Foreign Application Priority Data
Jul. 7, 2006 (JP) 2006-187892

(51) Int. Cl. G06F 5/00

(52) U.S. Cl. 710/52

(57) ABSTRACT

When an LSI is connected to a plurality of memories that perform data transfers by a handshake access method, the need for the LSI to continuously output an access signal to a memory for a long period of time is eliminated. A hold circuit is provided between the LSI and the memory. The LSI outputs an access signal for specifying address information and a memory via a bus for a predetermined time period. The hold circuit holds the access signal and continually outputs the held access signal to the memory via a signal line connecting the hold circuit and the memory, in place of the LSI. After waiting until preparation for data transfer has been completed in the storage apparatus, the LSI again outputs an access signal and performs reading or writing of data.

### BACKGROUND OF INVENTION

1. Field of the Invention

The present invention relates to data transfers between an LSI and a memory, and in particular to a data access system that performs data transfers by handshake access.

2. Related Art

There are LSIs that are connected to an external storage apparatus such as a hard disk apparatus and exchange data by handshake access. In handshake access, an address signal specifying a position of data to be accessed is continuously output from the LSI to the storage apparatus.

The LSI continuously outputs the address signal for the following reason. The LSI must apply the address signal in order to specify from which address position data is to be read first or to which address position data is to be written first. In the storage apparatus, time is required to prepare for reading or writing the data, and the amount of time differs according to the storage apparatus. Also, the storage apparatus cannot transfer data unless the address signal is being received. Accordingly, when transferring data to a storage apparatus that performs data transfers by handshake access in which the timing according to which data is to be transferred must be notified, the LSI does not know at which timing data can be read or written, and therefore continuously outputs the address signal to the storage apparatus until the data transfer ends.

Japanese Patent Application Publication No. 2005-78305 discloses a data transfer apparatus that accesses a plurality of memories by switching access methods in accordance with the different access method of each memory. The different access methods referred to here include handshake access.

Incidentally, there is demand to minimize the number of bus signal lines in LSIs in order to suppress cost. Therefore, when an LSI is connected to a plurality of circuits or apparatuses, such as a storage apparatus, command busses and address busses for outputting instructions are often shared.

However, as described above, in handshake access an address bus is monopolized until access between the LSI and a storage apparatus ends. If monopolized, the address bus cannot be shared in order to output instructions to other circuits.

### SUMMARY OF INVENTION

In view of the above issue, an object of the present invention is to provide a data access system in which a bus is not monopolized for a long period of time even when performing a data transfer by handshake access.

In order to solve the above issue, the present invention is a data access system including: an access request circuit operable to output a first access signal that includes address information; a storage apparatus operable to receive a second access signal and access an internal storage area; and a hold circuit that is connected to the access request circuit by a plurality of bus lines, each being for transferring a different predetermined signal, that is connected to the storage apparatus by a signal line, and that is operable to receive the first access signal output by the access request circuit, and continuously output the second access signal to the storage apparatus until the access in the storage apparatus has ended, the second access signal indicating content identical to the first access signal, wherein the access request circuit outputs the first access signal for a predetermined time period that is shorter than from when the first access signal is output to the hold circuit until when the access in the storage apparatus has ended.

Also, the present invention is a data access apparatus that performs memory access with an external storage apparatus by a handshake method, including: an access request circuit operable to output a first access signal that includes address information; and a hold circuit that is connected to the access request circuit by a plurality of bus lines, each being for transferring a different predetermined signal, that is connected to the storage apparatus by a signal line, and that is operable to receive the first access signal output by the access request circuit, and continuously output a second access signal to the storage apparatus until the access in the storage apparatus has ended, the second access signal indicating content identical to the first access signal, wherein the access request circuit outputs the first access signal for a predetermined time period that is shorter than from when the first access signal is output to the hold circuit until when the access in the storage apparatus has ended.

Also, the present invention is a data access integrated circuit that has been mounted in a data access apparatus that performs memory access with an external storage apparatus by a handshake scheme, the data access integrated circuit including: an access request circuit operable to output a first access signal that includes address information; and a hold circuit that is connected to the access request circuit by a plurality of bus lines, each being for transferring a different predetermined signal, that is connected to the storage apparatus by a signal line, and that is operable to receive the first access signal output by the access request circuit, and continuously output a second access signal to the storage apparatus until the access in the storage apparatus has ended, the second access signal indicating content identical to the first access signal, wherein the access request circuit outputs the first access signal for a predetermined time period that is shorter than from when the first access signal is output to the hold circuit until when the access in the storage apparatus has ended.

Also, the present invention is a data access method used in a data access apparatus that performs data access with an external storage apparatus by a handshake scheme, the data access apparatus including an access request circuit and a hold circuit, including the steps of: causing the access request circuit to output a first access signal that includes address information to the hold circuit for a predetermined time period; and causing the hold circuit that is connected to the access request circuit by a plurality of bus lines, each being for transferring a different predetermined signal, and that is connected to the storage apparatus by a signal line, to receive the first access signal output by the access request circuit, and continuously output a second access signal to the storage apparatus until the data access in the storage apparatus has ended, the second access signal indicating content identical to the first access signal.

Here, the bus line can be used shared in order to connect to another circuit at a different time. Also, the access request circuit itself or an arbitration circuit performs control such that signals output from the access request circuit to the bus are not blocked by a signal output by another circuit.

As a result, whereas an address signal must be continuously applied to an address bus by the access request circuit in conventional technology, the hold circuit acts as a substitute that applies the address signal to the storage apparatus, thereby enabling the address bus to be freed up more quickly than in conventional technology.

There is a wait time from when the address signal is applied until preparation for data transfer is completed in the storage apparatus. The wait time differs depending on the efficiency of the storage apparatus, but is approximately several to several tens of μsec. Given that this is a rather long time in the world of LSIs, the access request circuit cannot output instructions to other memories etc. during this wait time, which results in a loss of time. Providing the hold circuit between the access request circuit and the storage apparatus in order to continuously apply the access signal eliminates the need for the access request circuit to wait until preparation for data transfer has been completed in the storage apparatus, thereby freeing up the address bus. Since the address bus can be used in, for example, access to another apparatus, the access request circuit can send an access request to another storage apparatus, thereby increasing access efficiency for access to another apparatus.

Also, in the data access system, the first access signal may further include information indicating one of a data read request and a data write request, the storage apparatus may include: a completion signal transmission unit operable to transmit, to the hold circuit, a completion signal indicating that preparation for a data transfer in accordance with the second access signal received from the hold circuit has been completed, and an input/output unit operable to output read-target data from an address specified by the second access signal, and output write write-target data to the internal storage area indicated by the address; the hold circuit may include: a completion signal transfer unit operable to transfer the completion signal to the access request circuit, and a data transfer unit operable to receive the write-target data that has been output by the access request circuit and transfer the received write-target data to the storage apparatus, and receive the read-target data that has been output by the input/output unit of the storage apparatus and transfer the received read-target data to the access request circuit; only in a first instance of outputting the first access signal, the access request circuit may continuously output the first access signal via one of the bus lines that is for transferring the first access signal, until the completion signal has been received from the hold circuit; and the access request circuit may include: a transmission/reception unit operable to transmit the write-target data via one of the bus lines that is for transferring the write-target data and receive the read-target data via one of the bus lines that is for transferring the read-target data, a measurement unit operable to measure an access wait time from the first instance of outputting the first access signal to the storage apparatus via the one of the bus lines for transferring the first access signal, until when the completion signal has been received from the hold circuit, and store therein the measured access wait time, and a control unit operable to, in a second and subsequent instances of applying the first access signal, again apply the first access signal via the one of the bus lines for transferring the first access signal when the access wait time stored in the measure unit has elapsed, the access wait time having begun when a previous instance of applying the first access signal for the predetermined time period has begun, and cause the transmission/reception unit to one of receive the read-target data and transmit the write-target data.

Also, in the data access apparatus, the first access signal may further include information indicating one of a data read request and a data write request; the hold circuit may include: a completion signal transfer unit operable to receive, from the storage apparatus, a completion signal indicating that the memory access has been completed, and transfer the completion signal to the access request circuit, and a data transfer unit operable to receive write-target data that has been output by the access request circuit and transfer the received write-target data to the storage apparatus, and receive read-target data that has been output by the storage apparatus and transfer the received read-target data to the access request circuit; only in a first instance of outputting the first access signal, the access request circuit may continuously output the first access signal via one of the bus lines that is for transferring the first access signal, until the completion signal has been received from the hold circuit, regardless of the predetermined time period; and the access request circuit may include: a transmission/reception unit operable to transmit the write-target data via one of the bus lines that is for transferring the write-target data and receive the read-target data via one of the bus lines that is for transferring the read-target data, a measurement unit operable to measure an access wait time from the first instance of outputting the first access signal to the storage apparatus via the one of the bus lines for transferring the first access signal, until when the completion signal has been received from the hold circuit, and store therein the measured access wait time, and a control unit operable to, in a second and subsequent instances of applying the first access signal, again apply the first access signal via the one of the bus lines for transferring the first access signal when the access wait time stored in the measure unit has elapsed, the access wait time having begun when a previous instance of applying the first access signal for the predetermined time period has begun, and cause the transmission/reception unit to one of receive the read-target data and transmit the write-target data.

Also, in the data access integrated circuit, the first access signal may further include information indicating one of a data read request and a data write request; the hold circuit may include: a completion signal transfer unit operable to receive, from the storage apparatus, a completion signal indicating that the memory access has been completed, and transfer the completion signal to the access request circuit, and a data transfer unit operable to receive write-target data that has been output by the access request circuit and transfer the received write-target data to the storage apparatus, and receive read-target data that has been output by the storage apparatus and transfer the received read-target data to the access request circuit; only in a first instance of outputting the first access signal, the access request circuit may continuously output the first access signal via one of the bus lines that is for transferring the first access signal, until the completion signal has been received from the hold circuit, regardless of the predetermined time period; and the access request circuit may include: a transmission/reception unit operable to transmit the write-target data via one of the bus lines that is for transferring the write-target data and receive the read-target data via one of the bus lines that is for transferring the read-target data, a measurement unit operable to measure an access wait time from the first instance of outputting the first access signal to the storage apparatus via the one of the bus lines for transferring the first access signal, until when the completion signal has been received from the hold circuit, and store therein the measured access wait time, and a control unit operable to, in a second and subsequent instances of applying the first access signal, again apply the first access signal via the one of the bus lines for transferring the first access signal when the access wait time stored in the measure unit has elapsed, the access wait time having begun when a previous instance of applying the first access signal for the predetermined time period has begun, and cause the transmission/reception unit to one of receive the read-target data and transmit the write-target data.

According to this structure, in a case of a first instance of accessing the storage apparatus, the access request circuit counts an access time until preparation for data transfer has been completed in the storage apparatus. Counting the access time enables determining a timing for again applying the access signal for a data transfer in second and subsequent instances of access to the storage apparatus.

Consequently, the bus line is freed up from after the access signal has been output until the access signal is output again for the data transfer, and the access request circuit can output an instruction to another circuit via the freed up bus line. Also, the data transfer can be performed without a loss of time since the access request circuit itself knows the timing for again outputting the access request signal.

Also, in the data access system, the storage apparatus may further include a wait time storage unit operable to have stored therein a wait time from when the second access signal has been received until when the preparation for the data transfer has been completed, and a notification unit operable to notify the wait time to the access request circuit via the hold circuit, and after outputting the first access signal for the predetermined time period and thereafter waiting until the wait time notified by the notification unit has elapsed, the access request circuit may again output the first access signal to cause execution of the data transfer.

According to this structure, the access request circuit acquires the access time from the storage apparatus in advance, thereby enabling freeing up the address bus while counting the access time, even in a first instance of access.

Also, in the data access system, the hold circuit may further include a data storage unit operable to have stored therein data, and the hold circuit may receive a plurality of the first access signals, each including a different address information piece, read a plurality of data pieces from the storage apparatus, each data piece being read from an address corresponding to a different one of the received first access signals, store the plurality of read data pieces in the data storage unit, and output the plurality of data pieces in parallel from the data storage unit to the access request circuit via one or more of the bus lines.

The access request circuit can output a plurality of access instructions since the address bus is freed up more quickly than in conventional technology. According to the above structure, in a case of a plurality of data access requests, data transfers corresponding to each of the access requests can be performed in parallel at the same time. In a case of the data read bus or data write bus being shared between two storage apparatuses, the access request circuit only needs to output a read signal or write signal one time when requesting a data read or a data write.

Also, in the data access system, the access request circuit may specify, for each of the data pieces, one of the plurality of bus lines via which the hold circuit is to output the data piece, and the hold circuit may output each data piece via the corresponding bus line specified by the access request circuit.

According to this structure, in a case of-performing a plurality of data transfers, specifying the bus lines to be used by the hold circuit for the data transfers enables the access request circuit to know which data is being transferred via which bus line such that the data transfers are performed without an error. Also, if a plurality of storage apparatus are connected to the data bus, the LSI specifies the data transfer busses in order to enable the plurality of storage apparatuses to transfer data in parallel via the corresponding hold circuits connected thereto.

Also, in the data access system, the hold circuit may further include: a generation unit operable to, after outputting the read-target data from the address specified by the first signal, generate a third access signal that includes new address information indicating a value of the address that has been varied a predetermined value n, n being a natural integer, an address information storage unit operable to have stored therein the new address information, and a judgment unit operable to judge whether the new address information stored in the address information storage unit matches address information included in the first access signal that has been output by the access request circuit in a next instance; the hold circuit may output the third access signal generated by the generation unit to the storage apparatus; and if the judgment unit judges affirmatively, the storage apparatus may output the read-target data from an address corresponding to the new address information to the access request circuit via the hold circuit.

According to this structure, the hold circuit accesses an address following the previously accessed address, without an access request from the access request circuit.

Given that the hold circuit performs accesses in advance, if the next access request received from the access request circuit matches an address specified by the hold circuit, the hold circuit can immediately perform a data transfer.

Also, in the data access system, the hold circuit may further include a storage unit operable to have stored therein the read-target data from the storage apparatus at the address corresponding to the new address information included in the third access signal generated by the generation unit, the generation unit may generate a new third access signal indicating a new address value after the storage unit has stored the read-target data corresponding to the previously generated third access signal, and if an address specified by a next first access signal that has been output by the access request circuit matches the address where the read-target data stored in the storage unit was stored in the storage apparatus, the data transfer unit may immediately transfer the read-target data stored in the storage unit.

According to this structure the hold circuit, which includes a storage unit for storing data, stores a plurality of data pieces in advance. If an access request that corresponds to the address of a data piece stored in the hold circuit is received from the access request circuit, the hold circuit can immediately perform a data transfer. Also, the inclusion of the storage unit enables a plurality of data pieces to be stored in advance, thereby raising the probability of matching addresses and the probability of an immediate data transfer.

### BRIEF DESCRIPTION OF DRAWINGS

These and other objects, advantages, and features of the invention will become apparent from the following description thereof taken in conjunction with the accompanying drawings, which illustrate specific embodiments of the present invention.

In the drawings:

FIG. 1 is a block diagram showing a functional structure of a microcontroller, a hold circuit and a storage apparatus pertaining to a data access system of embodiment 1;

FIG. 2 is a timing chart showing data transitions in a case of a first instance of access from the microcontroller to the storage apparatus in embodiment 1;

FIG. 3 is a timing chart showing data traveling on signal lines in a case of second and subsequent instances of access from the microcontroller to the storage apparatus in embodiment 1;

FIG. 4 is a flowchart showing operations pertaining to data access performed by the microcontroller of embodiment 1;

FIG. 5 is a block diagram showing a functional structure of a microcontroller, a hold circuit and a storage apparatus pertaining to a data access system of embodiment 2;

FIG. 6 is a timing chart showing data transitions in a case of two substantially simultaneous instances of data access in embodiment 2;

FIG. 7 is a block diagram showing a functional structure of a microcontroller, a hold circuit and a storage apparatus pertaining to a data access system of embodiment 3;

FIG. 8 is a flowchart showing processing by which the microcontroller acquires an access time from the storage apparatus in embodiment 3;

FIG. 9 is a block diagram showing a functional structure of a microcontroller, a hold circuit and a storage apparatus pertaining to a data access system of embodiment 4;

FIG. 10 is a timing chart showing data transitions in embodiment 4;

FIG. 11 is a flowchart showing operations by which the hold circuit performs access without an instruction from a BCU in embodiment 4;

FIG. 12 is a block diagram showing a functional structure of a microcontroller, a hold circuit and a storage apparatus pertaining to a data access system of embodiment 5;

FIG. 13 is a timing chart showing data transitions in embodiment 5; and

FIG. 14 is a flowchart showing operations by which the hold circuit performs access and acquires data without an instruction from a BCU in embodiment 5.

### DETAILED DESCRIPTION OF PREFERRED EMBODIMENTS

Embodiments of a data access system of the present invention are described below with reference to the drawings.

### Embodiment 1

Overview

In a data transfer between a microcontroller and a storage apparatus, a signal specifying the storage apparatus, a signal specifying a read or write request, and a signal specifying an address in a storage area in the storage apparatus are continuously received by the storage unit until the data transfer ends.

In conventional technology, the microcontroller must continuously apply signals to the storage apparatus and wait until the storage apparatus has completed preparation for a data transfer. Given that another access request cannot be output during the waiting period, a hold circuit is provided between the microcontroller and the storage apparatus. The microcontroller applies an access request signal to the hold circuit for a predetermined period such as tens of nsec (nanoseconds), and the hold circuit stores the access request signal and continuously applies the access request signal to the storage apparatus in place of an access request circuit. When the storage apparatus has completed preparation for the data transfer, a signal specifying the storage apparatus and a signal specifying a read or write request are again applied, and the data transfer is executed.

This enables more quickly freeing up the address bus connecting the microcontroller and the hold circuit.

Structure

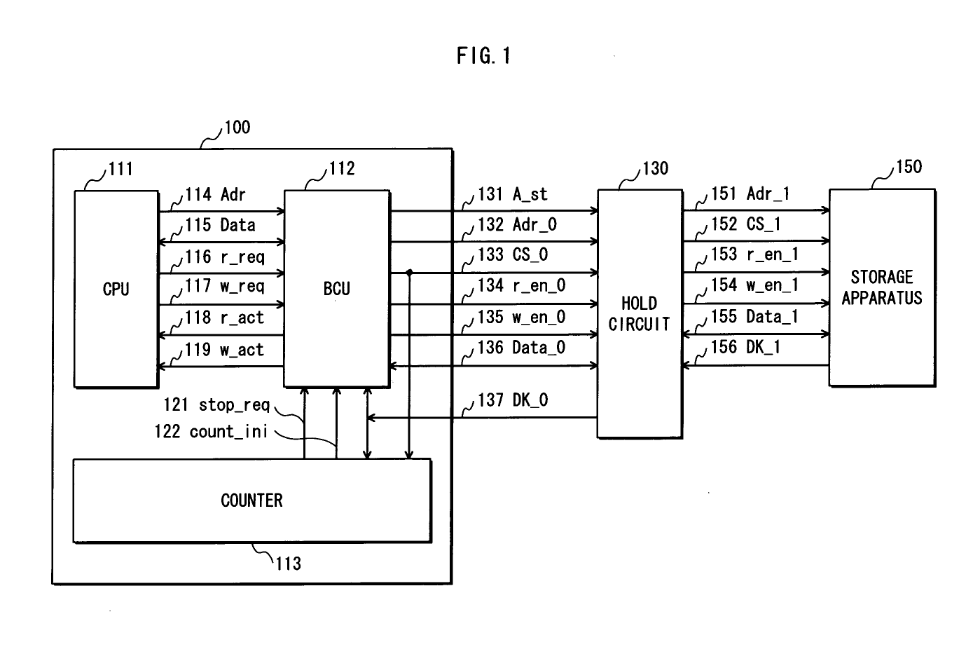

The block diagram of FIG. 1 shows a functional structure of a data access system pertaining to the present invention.

As shown in FIG. 1, the data access system includes a microcontroller 100, a hold circuit 130 and a storage apparatus 150.

The aforementioned access request circuit corresponds to the microcontroller 100, the aforementioned hold circuit corresponds to the hold circuit 130, and the aforementioned storage apparatus corresponds to the storage apparatus 150.

The microcontroller 100 includes a CPU (Central Processing Unit) 111, a BCU (Bus Control Unit) 112 and a counter 113. The microcontroller 100 accesses the storage apparatus 150 and exchanges data via the hold circuit 130.

The CPU 111 is a processor that reads and writes data to/from the storage apparatus 150. More specifically, the CPU 111 causes the BCU 112 to output requests to the storage apparatus 150. The CPU 111 is connected to the BCU 112 by signal lines 114 to 119.

The signal line 114 is a signal line via which the CPU 111 transmits, to the BCU 112, a signal indicating which address in the storage apparatus 150 is to be accessed. Address information “Adr” that specifies from which address data is to be read or to which address data is to be written is transmitted via the signal 114.

The signal line 115 is a signal line that carries actual data being transmitted/received between the CPU 111 and the BCU 112. The signal line 115 is composed of N signal lines and carries N bits of data at a time. Actual data information “Data” is transmitted/received via the signal line 115.

The signal line 116 is a signal line via which the CPU 111 applies, to the storage apparatus 150, a read request signal r_req for requesting a data read. The signal line 116 is composed of one signal line, and data is indicated by an H (High) level or L (Low) level voltage value. The application of an H level voltage indicates that the CPU 111 is requesting a data read.

The signal line 117 is a signal line via which the CPU 111 applies, to the storage apparatus 150, a write request signal w_req for requesting a data write. The signal line 117 is composed of one signal line, and data is indicated by an H level or L level voltage value. The application of an H level voltage indicates that the CPU 111 is requesting a data write.

The signal line 118 is a signal line via which the BCU 112 applies a read completion signal r_act. The signal line 118 is composed of one signal line, and data is indicated by an H level or L level voltage value. When an H level voltage is being applied, the CPU 111 ends access to the requested address position of data in the storage apparatus 150, recognizes that data can be received, and begins receiving data.

The signal line 119 is a signal line via which the BCU 112 applies a write completion signal w_act. The signal line 119 is composed of one signal line, and data is indicated by an H level or L level voltage value. When an H level voltage is being applied, the CPU 111 ends access to the requested address position of data in the storage apparatus 150, recognizes that data can be transmitted, and begins transmitting data.

The BCU 112 manages the bus lines that connect the microcontroller to an external device, and judges which requested data to prioritize. Although not depicted, in the exemplary case of provision of a CPU, DMA (Direct Memory Access) controller etc. that additionally request access to an external apparatus, the BCU 112 judges which access request from which apparatus to prioritize. The BCU 112 also mediates the transmission/reception of data to/from the external apparatus.

The BCU 112 is connected to the CPU 111 by the signal lines 114 to 119, as described above, and is additionally connected to the counter 113 by signals lines 121, 122 and 137. The BCU 112 is also connected to the hold circuit 130 by bus lines 131 to 137.

The bus line 131 is a signal line via which the BCU 112 applies, to the hold circuit 130, an update signal A_st for requesting an update of held data pertaining to a memory access. The bus line 131 is composed of one signal line, and data is indicated by an H level or L level voltage value. The application of an H level voltage indicates that an update of conditions of units in the hold circuit 130 is being requested.

The bus line 132 is a signal line used in the application of an address signal Adr_0 for specifying an address position of the storage apparatus 150 that has been determined in accordance with an address signal Adr. Note that the address signal Adr and the address signal Adr_0 indicate the same content.

The bus line 133 is a signal line used in the application of a chip select signal CS_0 that is included in the address signal Adr and indicates information for specifying a storage apparatus if there are a plurality of storage apparatuses.

The bus line 134 is a signal line used in the application of a read signal r_en_0. The application of a voltage on the bus line 134 indicates that the BCU 112 is outputting a data read request to the storage apparatus 150.

The bus line 135 is a signal line used in the application of a write signal w_en_0. The application of a voltage on the bus line 135 indicates that the BCU 112 is outputting a data write request to the storage apparatus 150.

The bus line 136 is composed of N signal lines, and carries N bits of data at a time.

The bus line 137 is a signal line via which the hold circuit 130 applies, to the BCU 112 and the counter 113, an access completion signal DK_0 indicating that access to the requested address position in the storage apparatus 150 has been completed.

The counter 113 is connected to the BCU 112 by the signal lines 121 and 122, and is also connected to the bus lines 133 and 137.

The counter 113 determines a timing for a data read or data write in the second and subsequent instances of access from the microcontroller 100 to the storage apparatus 150. When the microcontroller first accesses the storage apparatus 150, the counter 113 counts a time n required for the access. The counter 113 then counts down from n for the second and subsequent instances of access from the microcontroller 100 to the storage apparatus 150, and upon reaching 1, applies, to the BCU 112 via the signal line 121, a signal stop_req for requesting the establishment of a connection between the CPU 111 and the storage apparatus 150. Establishing connection involves the BCU 112 outputting the chip select signal CS_0 and either the read signal r_en_0 or the write signal w_en_0 to the hold circuit 130. Also, when the microcontroller 100 first accesses the storage apparatus 150, the counter 113 begins counting upon receiving a count initiation signal count_ini applied by the BCU 112 via the signal line 122. The counter 113 stops counting upon receiving the access completion signal DK_0. The counter 113 stores a time obtained by the counting as the time required to access the storage apparatus 150.

The hold circuit 130 receives and holds a memory access signal from the BCU 112, transmits the held memory access signal to the storage apparatus 150, and transmits/receives data. The hold circuit 130 accesses the storage apparatus 150 by a handshake system.

As described above, the hold circuit 130 is connected to the BCU 112 by the bus lines 131 to 137, and is additionally connected to the storage apparatus 150 by signal lines 151 to 156.

The storage apparatus 150 stores data and transmits/receives data. The storage apparatus 150 is specifically composed of, for example, a hard disk apparatus or a memory such as a RAM.

Operations

The following describes operations of the data access system of embodiment 1 with references to the drawings.

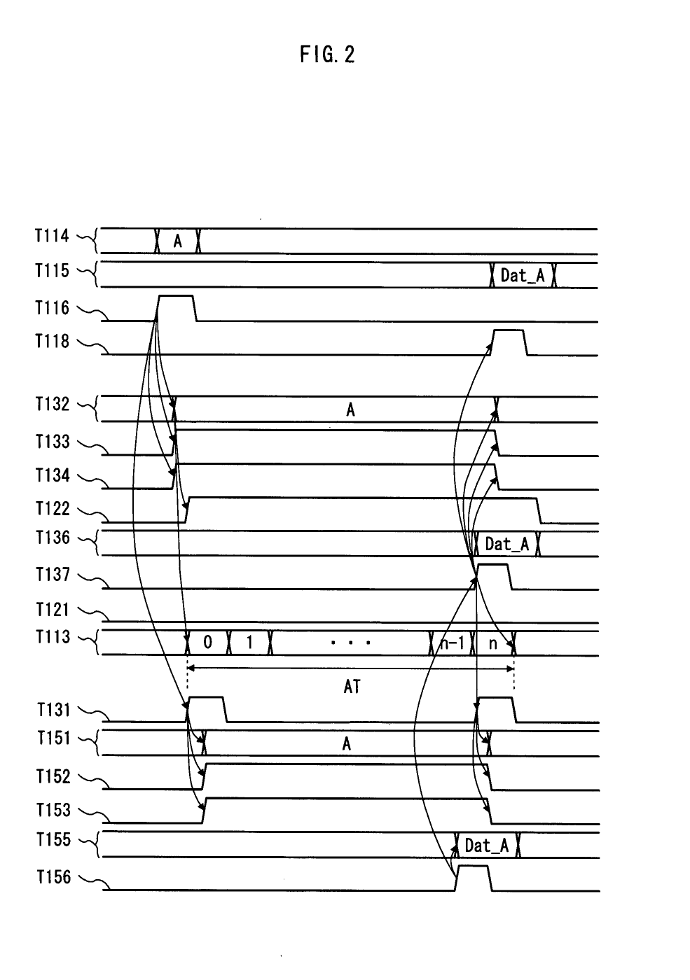

FIG. 2 is a timing chart showing conditions of signals traveling the signal lines when the microcontroller 100 first accesses the storage unit 150. In FIG. 2, the time axis is oriented along the horizontal axis, where time elapses from left to right. The values following signals “T” correspond to the reference characters of the signal lines or functional units shown in FIG. 1. Also, arrows connecting the signals indicate the causes and results of rises and falls in the signals.

The following describes an exemplary case of a data read. A case of a data write would be the same, with the exception of writing instead of reading.

First, the CPU 111 requests data at an address A in the storage apparatus 150 by, as shown by a signal T114, applying the address A to the BCU 112 via the signal line 114. As shown by a signal T116, the CPU 111 simultaneously applies the read request signal r_req indicating a data read.

Thereafter, as shown by a signal T132, the BCU 112 applies the address A via the bus line 132. As shown by a signal T133, the BCU 112 also applies the chip select signal CS_0 via the bus line 133 and the read signal r_en_0 via the bus line 134. The BCU 112 also applies the update signal A_st via the bus line 131.

As shown by a signal T122, the BCU 112 also simultaneously applies the count initialization signal count_ini via the signal line 122. The application of the count initialization signal count_ini causes, as shown by a signal T113, the counter 113 to initiate counting the access time.

Upon receiving the update signal A_st, the hold circuit 130 stores the signals received from the BCU 112 in an internal buffer, and applies signals having the same content via signal lines 151 to 153.

Upon receiving an address signal Adr_1, a chip select signal CS_1 and a read signal r_en_1, the storage apparatus 150 begins accessing the address specified by the address signal Adr_1, and prepares for data transmission. As shown by a signal T156, upon completing preparation for data transmission, the storage apparatus 150 applies an access completion signal DK_1 indicating that access preparation has been completed via a signal line 156.

The hold circuit 130 receives the access completion signal DK_1, and as shown by a signal T137, applies the access completion signal DK_0 via the bus line 137.

The counter 113 receives the access completion signal DK_0, and ends counting the access time. The counter 113 then stores the counted time n.

As shown by a signal T136, the hold circuit 130 receives data Dat_A indicated by the address A, and transfers the received data Dat_A to the BCU 112.

The CPU 111 receives the data Dat_A via the BCU 112, whereafter processing ends.

This completes the description of operations performed by the various functional units when the microcontroller 100 first accesses the storage apparatus 150.

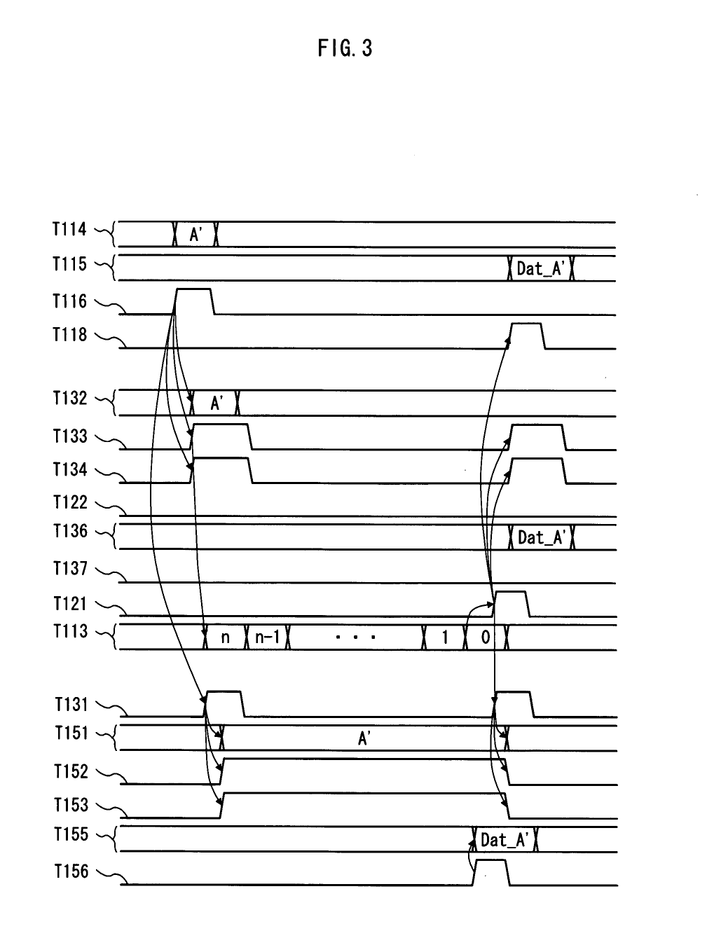

The following describes signals applied to the signal lines when the microcontroller 100 accesses the storage apparatus 150 for the second and subsequent times, with reference to the timing chart of FIG. 3.

First, as shown by the signals T114 and T116, an address signal Adr and a read request signal r_req are applied from the CPU 111 to the BCU 112. As shown by the signal T114, the address signal Adr specifies an address “A′”.

Thereafter, the BCU 112 applies, to the hold circuit 130, the address signal Adr_0 via the bus line 132, the chip select signal CS_0 via the bus line 133, and the read signal r_en_0 via the bus line 134. As shown by the signal T132, the address signal Adr_0 specifies the same address “A′” as the address signal Adr.

Also, as shown by the signal T113, the hold circuit 130 receives the chip select signal CS_0, and the counter 113 simultaneously begins counting the time n for accessing the storage apparatus 150.

The hold circuit 130 receives the update signal A_st, the address signal Adr_0, the chip select signal CS_0, and the read signal r_en_0, and as shown by the signals T151 to T153, the hold circuit 130 begins accessing the storage apparatus 150 by applying the address signal Adr_1, the chip select signal CS_1 and the read signal r_en_1 via the signal lines 151, 152 and 153 respectively.

As shown by the signal T113, upon counting down from the access time n and reaching “0”, the counter 113 raises the potential of the signal line 121 to the H level, and outputs an end request signal stop_req to the BCU 112. Here, as shown by the signal T155, preparation for transferring data Dat_A′ that corresponds to the address A′ has been completed.

The BCU 112 receives the end request signal stop_req, and as shown by the signal T131, outputs the update signal A_st to the hold circuit 130 via the bus line 131. As shown by the signals T133 and T134, the BCU 112 also simultaneously raises the potentials of the bus lines 133 and 134, and outputs the chip select signal CS_0 and the read signal r_en_0.

The application of the chip select signal CS_0 and the read signal r_en_0 enables the data transfer from the hold circuit 130 to the BCU 112, and as shown by the signal T136, the data Dat_A′ is transferred via the data bus 136.

The BCU 112 receives the data Dat_A′, and as shown by the signal T115, transfers the data Dat_A′ to the CPU 111 via the signal line 115.

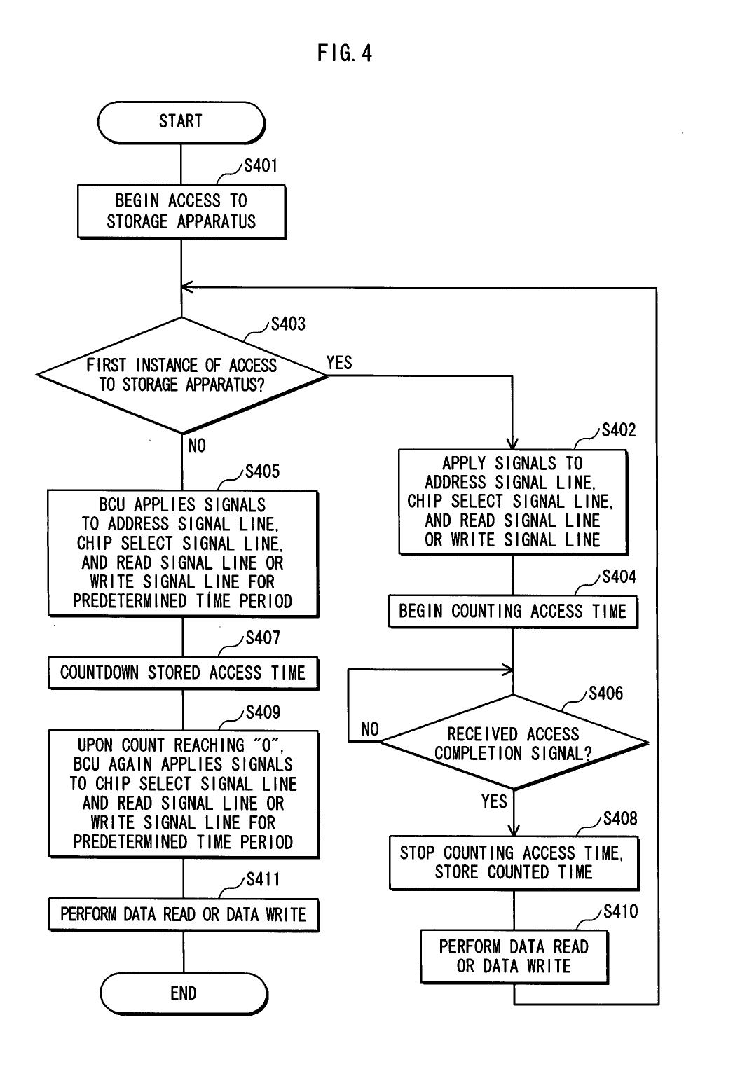

FIG. 4 is a flowchart showing the flow of the timing charts shown in FIGS. 2 and 3, from the viewpoint of operations performed by the microcontroller 100.

As shown in FIG. 4, the CPU 111 applies, to the BCU 112, a signal requesting access to the storage apparatus 150 (step S401).

The BCU 112 detects whether the access is a first instance of access to the storage apparatus 150 (step S403). This detection can be performed by keeping a history of past accesses to the storage unit specified by the address signal Adr applied via the signal line 114.

Upon detecting that the access is the first instance of access (step S403:YES), the BCU 112 applies the address signal Adr_0 via the bus line 132. The BCU 112 also applies the chip select signal CS_0 via the bus line 133. Also, the BCU 112 applies the read signal r_en_0 via the bus line 134 if the access request received from the CPU 111 is a data read request, and applies the write signal w_en_0 via the bus line 135 if the received access request is a data write request (step S402).

The BCU 112 also simultaneously outputs the count initialization signal count_ini to the counter 113 via the signal line 122. Upon receiving the count initialization signal, the counter 133 begins counting the access time (step s404).

The counter 113 detects whether the access completion signal DK_0, which indicates that access preparation has been completed, has been output from the hold circuit 130 (step S406). The counter 113 continues counting while the output of the access completion signal DK_0 has not been detected (step S406:NO).

Upon detecting that the access completion signal DK_0 has been output from the hold circuit 130 (step S406:YES), the counter 113 stops counting the access time. The counter 113 then stores the counted time n (step S408).

Thereafter, the reading of data from or the writing of data to the storage apparatus 150 is performed (step S410).

On the other hand, upon detecting that the access to the storage apparatus 150 is not the first instance of access (step S403:NO), the BCU 112 applies the address signal Adr_0 and the chip select signal CS_0 via the bus lines 132 and 133 respectively for a predetermined time period. The BCU 112 also applies a signal specifying a data read or a data write via the bus line 134 or 135 respectively for a predetermined time period (step S405). It is sufficient for the predetermined time period referred to above to be any time period shorter than the time period from when access to the storage apparatus 150 begins until preparation for the data transfer has been completed, such as several nsec.

The counter 113 detects that the chip select signal CS_0 has been applied and that the count initialization signal count_ini has not been applied, and begins counting down the time n for accessing the storage apparatus 150 (step S407).

Upon the count reaching “0”, the counter 113 outputs the end request signal stop_req to the BCU 112. The BCU 112 receives the end request signal stop_req from the counter 113 and again applies the chip select signal CS_0 and the read or write signal for the predetermined time period (step S409).

The microcontroller 100 reads data from or writes data to the storage apparatus 150 (step S410), whereafter processing ends.

This ends the description of operations performed in the data access system.

As described above, the address signal is applied to the bus line 132 only during the predetermined period for the second and subsequent instances of access to the storage apparatus 150, thereby causing the bus line 132 to be freed up more quickly than in conventional technology. The address bus can therefore be used for other purposes, such as access to a storage apparatus other than the storage apparatus 150.

### Embodiment 2

Whereas a case of a single storage apparatus is described in embodiment 1, a case of a plurality of storage apparatuses is described in embodiment 2. Embodiment 2 also describes technology for, when access requests for two storage apparatuses are received substantially simultaneously during a data transfer, reducing the time required to complete the data transfers.

Structure

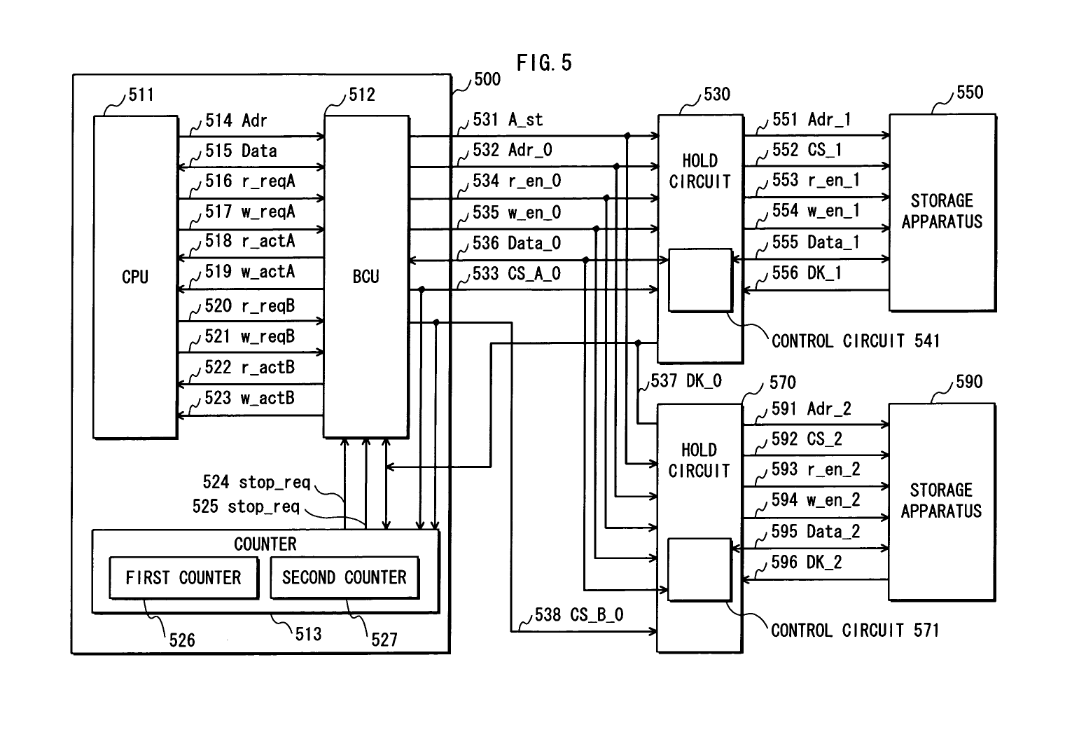

The following describes a data access system of embodiment 2 with reference to the functional block diagram of FIG. 5. The following description focuses on differences from the structure described in embodiment 1.

As shown in FIG. 5, the data access system of embodiment 2 has the same structure as in embodiment 2, with the addition of another hold circuit and another storage apparatus.

As shown in FIG. 5, the data access system of embodiment 2 includes a CPU 511, a BCU 512, a counter 513, a hold circuit 530, a storage apparatus 550, a hold circuit 570, and a storage apparatus 590.

Here, the CPU 511 and BCU 512 have substantially the same functions as the CPU 111 and BCU 112 of embodiment 1, the hold circuits 530 and 570 have substantially the same functions as the hold circuit 130 of embodiment 1, and the storage apparatus 550 and 590 have substantially the same functions as the storage apparatus 150 of embodiment 1. The following describes structure portions that differ from embodiment 1.

The CPU 511 can read data from and write data to both of the storage apparatuses 550 and 590.

Also, the counter 513 includes a first counter 526 and a second counter 527. The first counter 526 counts a time for accessing the storage apparatus 550, and the second counter 527 counts a time for accessing the storage apparatus 590.

The hold circuit 530 includes a control circuit 531. Also, the hold circuit 570 includes a control circuit 571. The control circuits 531 and 571 determine, in accordance with an instruction from the BCU 512, which bandwidth of a data bus to use during a data transfer, and transfer data to the BCU 512 via the determined data bus. Specifically, the control circuits 531 and 571 receive, from the BCU 512, data specifying whether the data bus to be used in the data transfer is high-order or low-order, and perform the data transfer via the determined data bus. For example, assuming that the data bus 536 is a 16-bith width bus, upon receiving data specifying a low-order data bus, the control circuit 531 or 571 performs the data transfer via the low-order eight bits of a data bus.

The CPU 511 and BCU 512 are connected together by signal lines 514 to 523. The signal line 514 is used in the application of a signal for specifying an address in the storage apparatus 550 or 590 to be accessed. The signal line 515 is used in the exchange of data between the CPU 511 and the BCU 512. The signal line 515 need not be a single signal line, and may have, for example, a 10 Mbps data transfer bandwidth. The signal line 516 is used in the application of a read request signal r_reqA for requesting the reading of data from the storage apparatus 550. The signal line 517 is used in the application of a write request signal w_reqA for requesting the writing of data to the storage apparatus 550. The signal line 518 is used in the application of a read completion signal r_actA indicating that the reading of data from the storage apparatus 550 has been completed. The signal line 519 is used in the application of a write completion signal w_actA indicating that the writing of data to the storage apparatus 550 has been completed.

The signal line 520 is used in the application of a read request signal r_reqB for requesting the reading of data from the storage apparatus 590. The signal line 521 is used in the application of a write request signal w_reqB for requesting the writing of data to the storage apparatus 590. The signal line 522 is used in the application of a read completion signal r_actB indicating that the reading of data from the storage apparatus 590 has been completed. The signal line 523 is used in the application of a write completion signal w_actB indicating that the writing of data to the storage apparatus 590 has been completed.

The BCU 512 and the counter 513 are connected together by signal lines 524, 525 and 537. The signal line 524 is a signal line via which the first counter 526 applies, to the BCU 512, a signal stop_req for determining a timing according to which the BCU 512 is to reapply a chip select signal and a read signal or write signal. Similarly to the signal line 524, the signal line 525 is a signal line via which the second counter 527 applies a signal stop_req. Note that although not depicted, the BCU 512 and counter 513 are also connected together by a signal line via which a count initialization signal is applied, similarly to embodiment 1.

The BCU 512 is connected to the hold circuit 530 by bus lines 531 to 537. The BCU 512 is also connected to the hold circuit 570 by the bus lines 531, 532, and 534 to 538. As shown in FIG. 5, the hold circuits 530 and 570 share the bus line 532 used in the application of the address signal Adr_0, the bus line 534 used in the application of the read signal r_en_0, the bus line 535 used in the application of the write signal w_en_0, and the bus line 536 used for data transfers. Note that the bus line 536 can transfer 16-bit data.

The bus lines 533 and 538 are used in the application of a chip select signal CS_A_0 and a chip select signal CS_B_0 respectively. The chip select signals CS_A_0 and CS_B_0 are signals for notifying the storage apparatuses 550 and 590 respectively that a data access request has been received by the hold circuits 530 and 570 respectively.

The hold circuit 530 and the storage apparatus 550 are connected together by signal lines 551 to 556. Also, the hold circuit 570 and the storage apparatus 590 are connected together by signal lines 591 to 596. The relationship between the hold circuit 530 and storage apparatus 550, as well as the hold circuit 570 and storage apparatus 590 is substantially the same as the relationship between the hold circuit 130 and storage apparatus 150 described in embodiment 1. One difference in the relationship of the hold circuit 550 and storage apparatus 550, as well as the hold circuit 570 and storage apparatus 590 from embodiment 1 is that the control circuits 541 and 571 are connected to the storage apparatuses 550 and 590 by the signal lines 555 and 595 respectively.

Operations

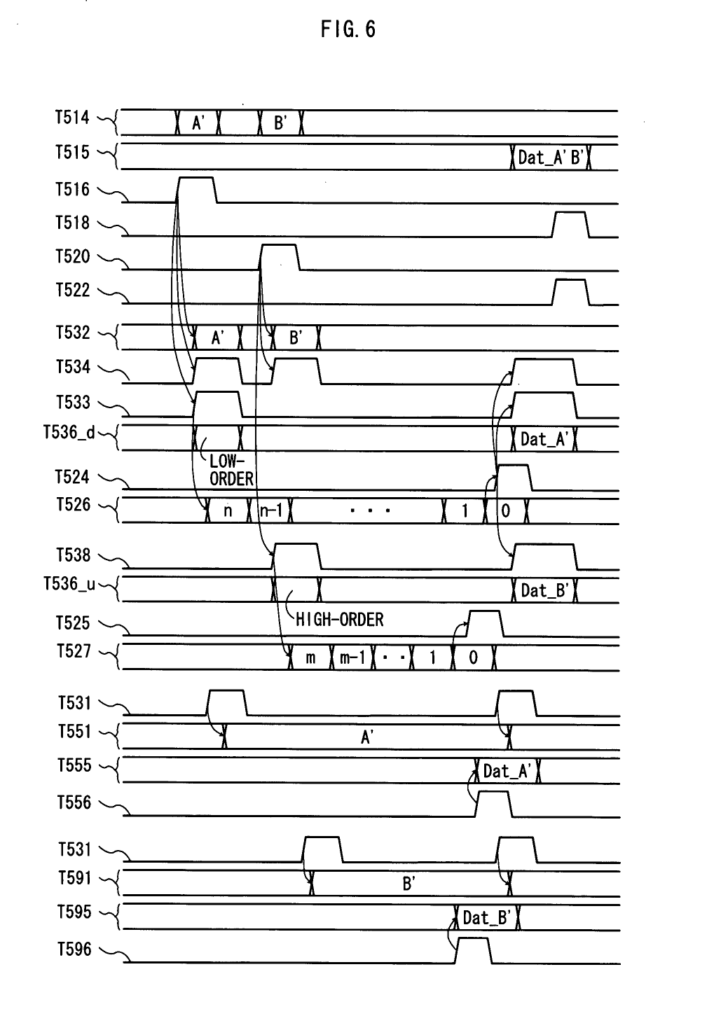

The following describes data transitions in the data access system of embodiment 2 with reference to the timing chart of FIG. 6. FIG. 6 shows a case in which the CPU 511 transmits an access request for the storage apparatus 550, and before access preparation has been completed, transmits an access request for the storage apparatus 590. Also, the request is a data read request, and the first and second counters 526 and 527 have already stored the access times for the storage apparatus 550 and 590 respectively. The access time for the storage apparatus 550 is time n, and the access time for the storage apparatus 590 is time m.

First, as shown by a signal T514, the CPU 511 transmits, to the BCU 512, an access request for address A′ of the storage apparatus 550 via the signal line 514. As shown by a signal T516, the CPU 511 also applies the read request signal r_reqA via the signal line 516.

The BCU 512 receives the address signal A′, and analyzes the received address signal A′ to determine to which of the storage apparatuses the access request pertains. Here, the access request is for the storage apparatus 550.

Upon receiving the address signal A′ and the read request signal r_reqA, the BCU 512 applies the address signal A′ via the bus line 532, applies the chip select signal CS_A_0 via the bus line 533, and applies the read signal r_en_0 via the bus line 534, as shown by signal lines T532 to T534. As shown by the signal T532, the BCU 512 applies the address signal A′ for the predetermined time period.

As shown by a signal T536_d, the BCU 512 also simultaneously outputs, to the control circuit 531 of the hold circuit 530, an instruction to transfer data with use of the low-order eight bits of the bus line 536.

The first counter 526 receives the chip select signal CS_A_0, and as shown by a signal T526, begins the countdown. The BCU 512 also applies the update signal A_st via the bus line 531, and the hold circuit 530 holds content indicated by the applied signal. As shown by a signal T551, upon receiving the update signal A_st, the hold circuit 530 applies the address signal via the signal line 551 until the data transfer has ended. Although not depicted in FIG. 6, the hold circuit 530 also simultaneously applies the chip select signal CS_1 and the read signal r_en_1 via the signal lines 552 and 553 respectively.

After transmitting the access request for the storage apparatus 550 to the BCU 112, the CPU 511 also transmits an access request for the storage apparatus 590 before the former data transfer has ended.

As shown by a signal T514, the CPU 511 applies an address signal B′ via the signal line 514. As shown a signal T520, the CPU 511 also simultaneously applies the read request signal r_reqB, which is a read request, via the signal line 520.

The BCU 512 receives the address signal B′, determines that the access request pertains to the storage apparatus 590, and applies a chip select signal CS_B_0 via the bus line 538. As shown by a signal T532, given that the bus line 532 used in the application of an address signal is free, the BCU 512 applies the address signal B′ via the bus line 532. Also, the read signal r_en_0 is applied via the bus line 534 as shown by a signal T534. Here, given that the BCU 512 has output an instruction indicating that the data Dat_A′ corresponding to the address A′ is to be transmitted via the low-order eight bits of the bus line 538, the BCU 512 outputs an instruction indicating that the data Dat_B′ corresponding to the address B′ is to be transmitted via the high-order eight bits of the bus line 536, as shown by a signal T536_{—}u.

The second counter 527 receives the chip select signal CS_B_0, and as shown by a signal T527, begins counting down from the time m for accessing the storage apparatus 590.

As shown by the signal T527, upon the count of the second counter 527 reaching “0”, the counter 513 applies the signal stop_req via the signal line 525, as shown by a signal T525. As shown by a signal T526, upon the count of the first counter 526 reaching “0”, the counter 513 applies the signal stop_req via the signal line 525, as shown by the signal T525.

Upon receiving the later signal stop_req (in FIG. 6, the counter of the first counter 526 reaches “0” after the second counter 527), the BCU 112 applies the read signal r_en_0 via the bus line 534, as shown by a signal T534.

As shown by signals T533 and T538, the BCU 512 also applies the chip select signals CS_A_0 and CS_B_0 via the bus lines 533 and 538 respectively.

As shown by a signal T536_{—}d, the control circuit 541 receives the chip select signal CS_A_0 and the read signal r_en_0, and transfers the data Dat_A′ to the BCU 512 via the low-order eight bits of the bus line 536.

Simultaneously, as shown by a signal T536_{—}u, the control circuit 517 receives the chip select signal CS_B_0 and the read signal r_en_0, and transfers the data Dat_B′ to the BCU 512 via the high-order eight bits of the bus line 536.

As shown by a signal T515, upon receiving the data Dat_A′ and Dat_B′, the BCU 512 transfers the received data to the CPU 511, whereafter processing ends.

This completes the description of the exemplary case of data transfers in embodiment 2. In the case of two data reads or data writes, the timing of the data transfers is aligned, thereby eliminating the need to apply the read signal r_en_0 twice, and commensurately lengthening the time during which the bus line 534 is free.

### Embodiment 3

Whereas in embodiment 1 an access time is counted when the microcontroller first accesses the storage apparatus, in embodiment 3 the access time is notified from the storage apparatus.

Structure

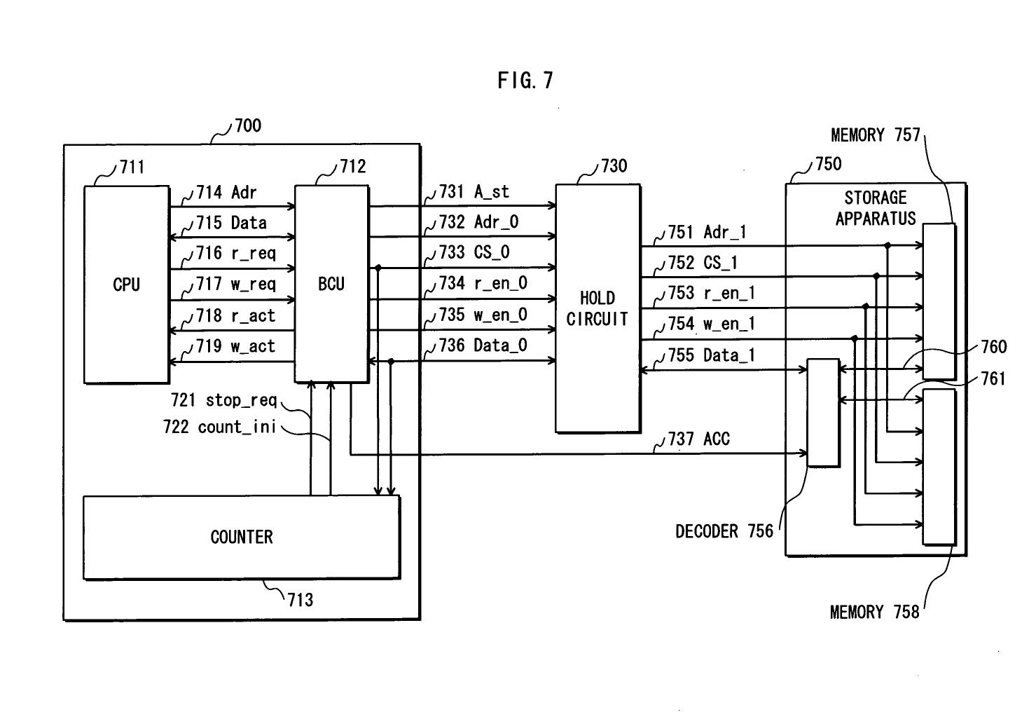

The following describes a data access system of embodiment 3 with reference to FIG. 7. The following description pertains to only differences from the structure of embodiment 1. The same reference characters have been given to structural portions that have the same functions as in embodiment 1, and descriptions thereof have been omitted.

As shown in FIG. 7, the data access system of embodiment 3 includes a microcontroller 700, a hold circuit 730, and a storage apparatus 750.

The BCU 712 performs the same functions as the BCU 112 of embodiment 1, and additionally applies an access count signal ACC to the storage apparatus 750 via a bus line 737 during a first instance of access.

Also, the storage apparatus 750 includes a decoder 756, a memory 757, and a memory 758.

The decoder 756 acquires access times from the memory 757 and the memory 758 via signal lines. Also, upon receiving the access count signal ACC, the decoder 756 transfers the access times to the hold circuit 730 via a bus line 755 for transferring data.

The hold circuit 730 receives the access times, and transfers the received access times to the counter 713.

The counter 713 stores the access times received from the decoder 756 via the hold circuit 730, instead of storing an internally counted access time.

This completes the description of structures in embodiment 3 that differ from embodiment 1.

Operations

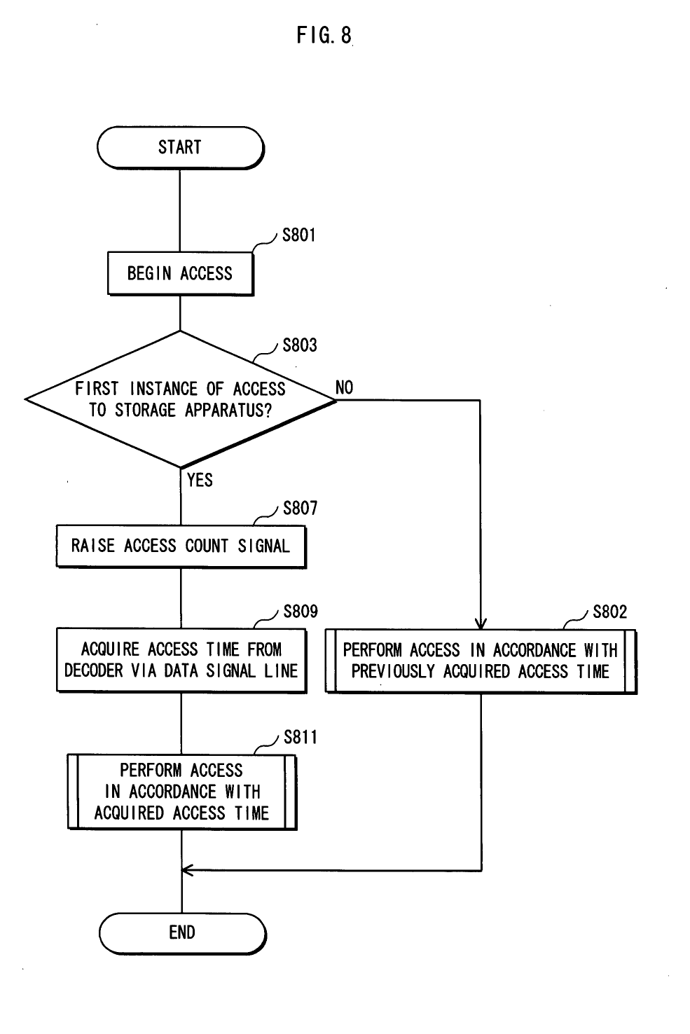

The following describes operations of the data access system of embodiment 3, and in particular the microcontroller 700, with reference to the flowchart of FIG. 8.

First, the CPU 711 transmits an access request to the BCU 712, and the BCU 712 applies signals required for access via various signal lines (step S801). Here, the BCU 712 also determines whether the access to be performed is a first instance of access to the storage apparatus 750 (step S803). This judgment is performed by referencing a history of past access.

In a case of determining that the access is not the first instance of access (step S803:NO), the data transfer is performed by the method described in embodiment 1 with use of the access time for the storage apparatus 750 that is stored in the counter 713 (step S802).

In a case of determining that the access is the first instance of access (step S803:YES), the BCU 712 applies the access count signal ACC via a bus line 737 (step S807).

The decoder 756 receives the access count signal ACC, acquires the access times from the memory 757 and memory 758, and transfers the acquired access times to the hold circuit 730 via the signal line 755. The hold circuit 730 transfers the access times to the counter 713 via the bus line 736. Thus the counter 713 acquires the access times from the memories of the storage apparatus 750 (step S809).

Access is performed by the same procedure as the second and subsequent instances of access described in embodiment 1, in accordance with the acquired access times (step S811), whereafter processing ends.

As described above, given that the microcontroller 700 acquires the access times from the storage apparatus before the data transfer is performed, the data transfer can be performed by the method of embodiment 1 for the second and subsequent instances of access, even if the microcontroller 700 is accessing the storage apparatus 750 for the first time. In other words, this enables more quickly freeing up the bus line 732 used in the application of address signals, even during the first instance of access. Access in embodiment 3 can therefore be expected to be more efficient than in embodiment 1.

### Embodiment 4

Embodiment 4 pertains to a technique for more quickly freeing up the address bus by a method that differs from the methods described in embodiments 1 to 3.

Structure

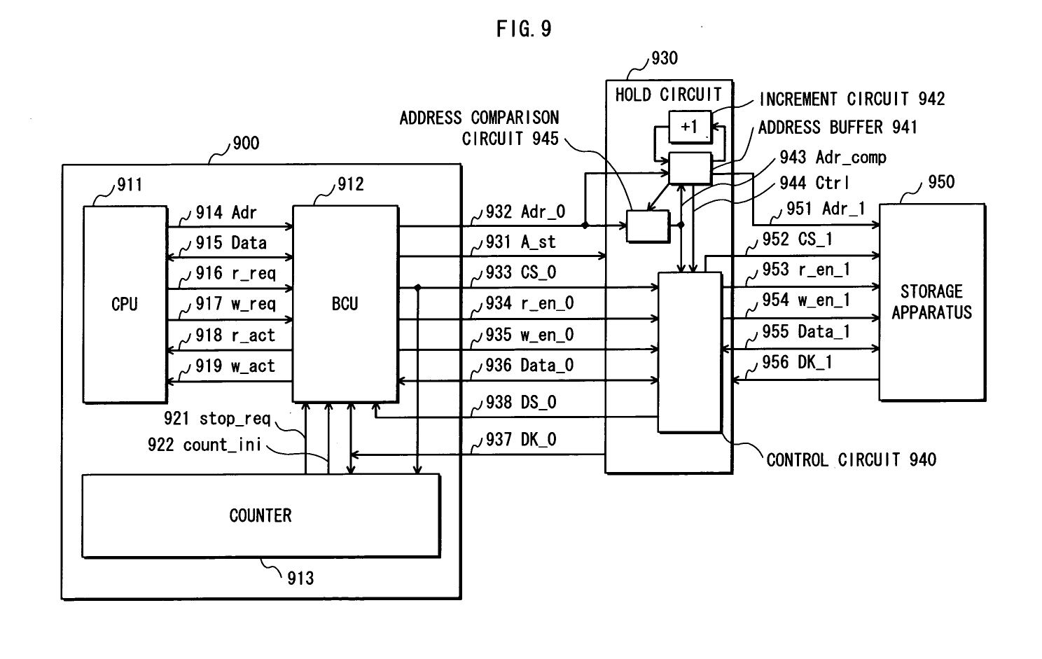

The following describes a data access system of embodiment 4 with reference to FIG. 9. The following description focuses on only portions of the structure that differ from embodiment 3. The same reference characters have been given to structural portions that have the same functions as in previous embodiments, and descriptions thereof have been omitted. In embodiment 4, the principal feature of the present invention is the inclusion of a hold circuit 930.

As shown in FIG. 9, the hold circuit 930 includes a control circuit 940, an address buffer 941, an increment circuit 942, and an address comparison circuit 945.

The address buffer 941 receives an address signal from a BCU 912, and holds the received address signal. After a data transfer to or from a storage area in a storage apparatus 950 that is specified by an address value indicated by the received address signal, the address buffer 941 outputs the address value to the increment circuit 942, and holds an address value output from the increment circuit 942. The held address value is applied as an address signal via a signal line.

The increment circuit 942 increments the address value output from the address buffer 942 by one, and outputs the incremented address value to the address buffer 942.

The address comparison circuit 945 compares the address value output from the BCU 912 and the address value output from the address buffer 941, and upon finding a match, outputs, to the control circuit 940, an address comparison signal Adr_comp that indicates that the address values match via a signal line 943.

The control circuit 940 receives the address comparison signal Adr_comp, and outputs a chip select signal CS_1 and a read signal r_en_1 or a write signal signal w_en_1. Upon receiving the address comparison signal Adr_comp, the control circuit 940 outputs a data strobe signal DS_0 to the BCU 912 via a signal 938. The data strobe signal DS_0 indicates that data can immediately be read or written.

The BCU 912 has the same functions as the BCUs of embodiments 1 to 3, as well as receives the data strobe signal DS_0, and executes data reading or writing without stopping output of the address signal or chip select signal during a predetermined time period. Given that in this case the data reading or writing has ended, there is no need for application of a second chip select signal CS_0 etc. as shown in embodiment 1.

Operations

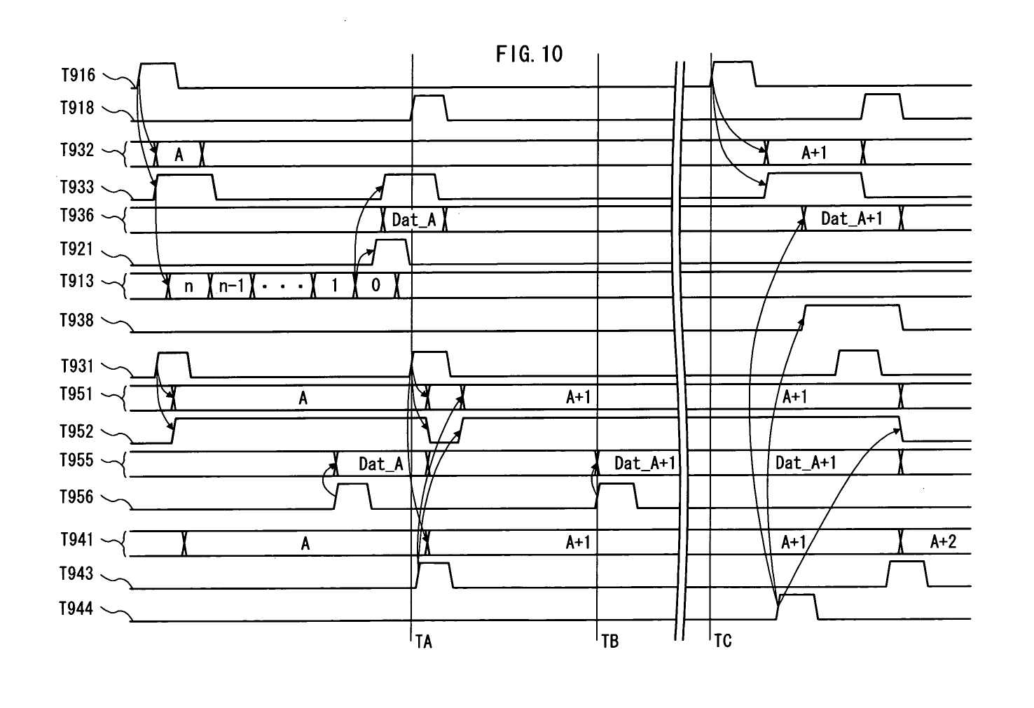

The following describes operations of the data access system of embodiment 4 with reference to the timing chart shown in FIG. 10.

First, access is performed similarly to FIG. 3 of embodiment 1 until time TA when the data read ends. Such operations are the same as in FIG. 3 of embodiment 1, and descriptions thereof have been omitted.

As shown by a signal T941, upon the data read ending, the address buffer 941 receives an update signal A_st, outputs the address value indicated thereby to the increment circuit 942, and stores the returned address value that has been incremented by one. As shown by the signal T941, the address value has been updated from “A” to “A+1”.

Upon receiving the address value “A+1”, the address buffer 941 applies an address signal Adr_1 via signal line 951 as shown by a signal T951. As shown by the signal T951, the address value indicates “A+1”.

At the same time, the hold circuit 930 raises a control signal Ctrl as shown by a signal T943. The control circuit 940 receives the control signal Ctrl, and as shown by a signal T952, applies a chip select signal CS_1 via a signal line 952. Note that although not depicted in FIG. 10, the control circuit 940 also outputs a read signal r_en_1 at the same time.

Upon access preparation being completed in the storage apparatus 950, the storage apparatus 950 applies an access completion signal DK_1 at time TB, as shown by a signal T956. At the same time, a data transfer is enabled as shown by a signal T955.

The hold circuit 930 continuously outputs the address signal Adr_1, the chip select signal CS_1 and the read signal r_en_1 until a new address signal has been output from the BCU 912.

As shown by a signal T916, a read request signal r_req is applied by the CPU 911 at time TC. Although not depicted in FIG. 10, an address signal Adr is of course also applied via a signal line 914. The address value indicated by the address signal is the address “A+1” of the storage apparatus 950.

The BCU 912 receives the read request signal r_req, and as shown by a signal T932, applies the address signal Adr_0 via a bus line 932. As shown by a signal T933, the BCU 912 also applies the chip select signal CS_0 via a bus line 933. Although not depicted in FIG. 10, the BCU 912 also applies the read signal r_en_0 via a bus line 934 at the same time.

The address comparison circuit 945 receives the address signal Adr_0, and compares the received address signal Adr_0 to the address stored in the address buffer 941. Here, the address signal Adr_0 received from the BCU 912 indicates “A+1” and matches the address stored in the address buffer 942.

The address buffer 941 receives the address comparison signal Adr_comp, and as shown by a signal T944, applies the control signal Ctrl to the control circuit 940 via a signal line 944 to request the control circuit 940 to output the data strobe signal DS_0.

The BCU 912 receives the data strobe signal DS_0, and as shown by a signal T936, immediately performs a data read, whereafter processing ends.

Note that as shown by a signal T941, the address value stored in the address buffer 941 is then incremented by one by the increment circuit 942, and access to a storage area of the storage apparatus 950 indicated by an address “A+2” begins.

This completes the description of operations performed in the data access system of embodiment 4 with reference to the timing chart of FIG. 10.

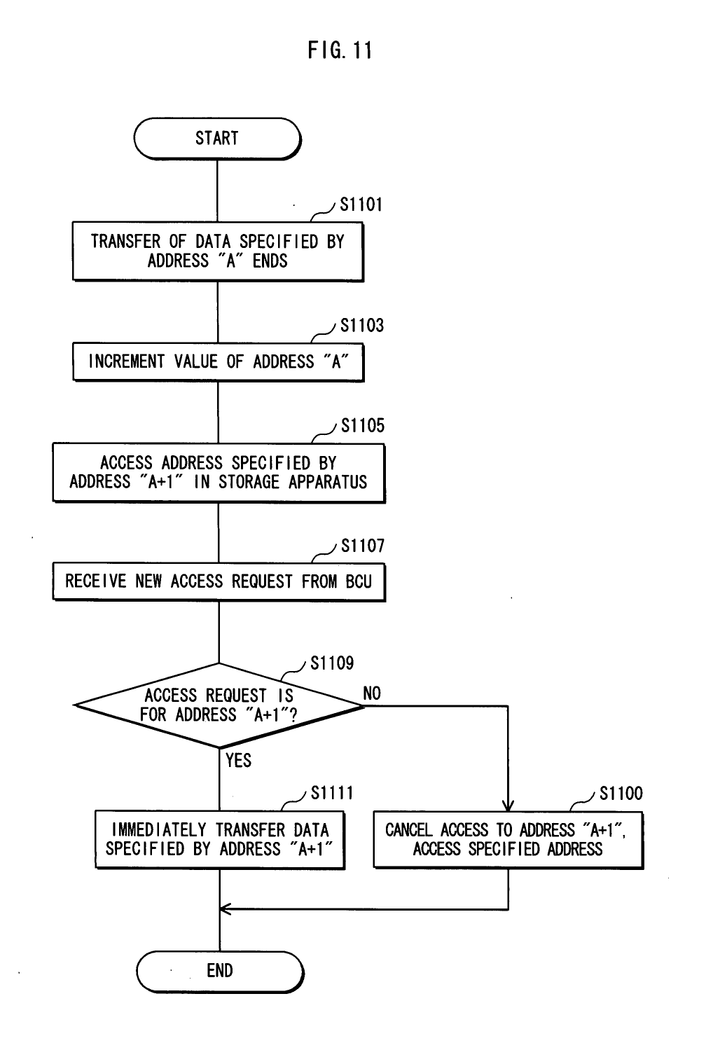

FIG. 11 is a flowchart showing condition transitions when viewing the operations of the timing chart of FIG. 10 as operations performed by the hold circuit 930.

First, a data transfer to or from the address A specified by the microcontroller 900 ends normally (step S1101).

he address buffer 941 of the hold circuit 930 outputs the address value “A” stored therein to the increment circuit 942. The address value “A” is then incremented by one to “A+1” by the increment circuit 942 and re-stored in the address buffer 941 (step S1103).

The address buffer 941 outputs an address signal 951 indicating the address value “A+1” to the storage apparatus 950. At the same time, the control circuit 940 outputs the chip select signal CS_1 that is necessary for access and the read signal r_en_1 to the storage apparatus 950 (step S1105).

The signals are continuously applied via the signal lines and access to the data A+1 is enabled until a new access request is received from the BCU 912.

A new access request then arrives from the BCU 912 (step S1107).

The address comparison circuit 945 compares the address value stored in the address buffer 941 to the new address signal Adr_0 that has been output from the BCU 912 (step S1109).

If the compared address values do not match (step S1109:NO), access to the address “A+1” is canceled. The address buffer 941 holds an address value indicated by the newly received address signal Adr_0, and outputs an address signal Adr_1. At the same time, the address buffer 941 outputs the control signal Ctrl to cause the control circuit 940 to output the chip select signal CS_0 and read signal r_en_0 received from the BCU 912 as a chip select signal CS_1 and a read signal r_en_1 respectively, and the data transfer is performed as usual by the same method as shown in FIG. 3 (step S1100).

If the address values match (step S1109:YES), the address buffer 941 outputs the address comparison signal 943 to the control circuit 940, which outputs the data strobe signal DS_0.

The BCU 912 receives the data strobe signal DS_0 as a notification that an immediate data transfer is possible, and reads the data A+1 from the storage apparatus 950 via the bus line 936 and via the hold circuit 930 (step S1111), whereafter processing ends.

As described above, after an access has been performed by the microcontroller 900, the hold circuit 930 automatically enables access to another address in the storage apparatus 950. This prepares for access to the other address in the storage apparatus 950 and enables an immediate data transfer when an access request for the other address is received from the microcontroller 900.

### Embodiment 5

Whereas embodiment 4 involves merely preparing for a next instance of access to the storage apparatus, in embodiment 5 even more data is read. Reading data that corresponds to a plurality of addresses enhances the technique described in embodiment 4.

Structure

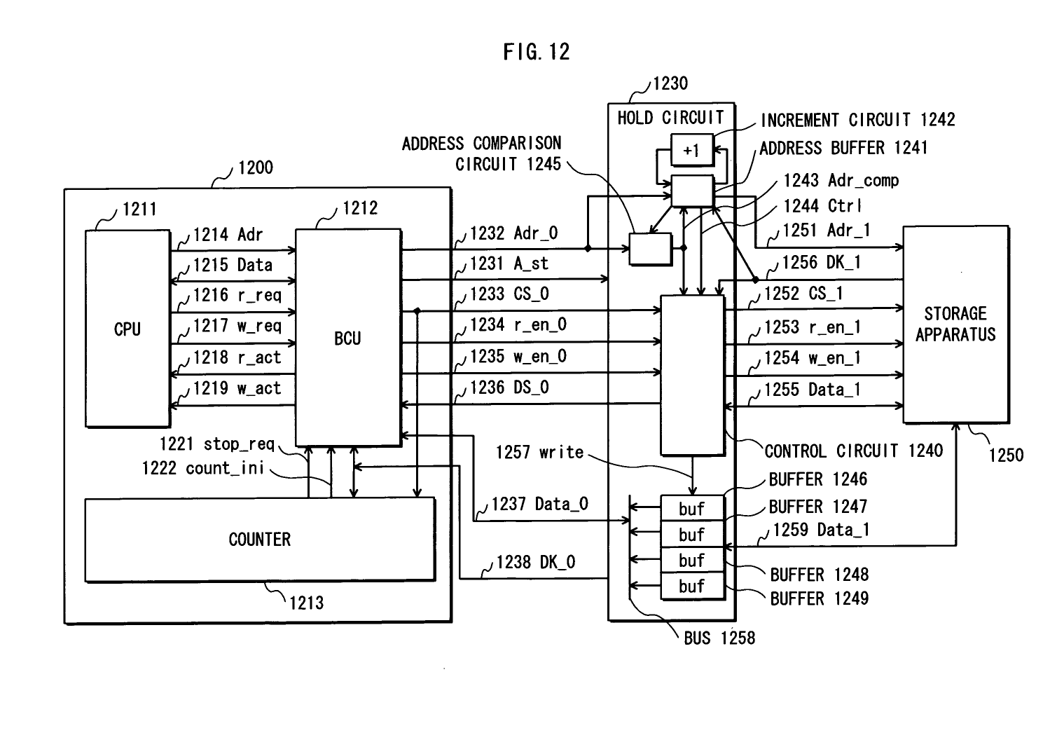

The following describes a structure of a data access system of embodiment 5 with reference to the functional block diagram of FIG. 12. Only structural portions that differ from embodiment 4 are described.

As shown in FIG. 12, a hold circuit 1230 has the same structure as the hold circuit 930 described in embodiment 4, as well as includes buffers 1246 to 1249.

The buffers 1246 to 1249 store data that has been transferred from a storage apparatus 1250, and output, to a BCU 1212, data that has been specified by a control circuit 1240.

Unlike embodiment 4, incrementing of an address value may be performed up to four times by an address buffer 1241 and an increment circuit 1242, the hold circuit 1230 accesses the storage apparatus 1250 at each of the addresses, and data corresponding to such addresses is stored in the buffers 1246 to 1249.

Each of the buffers 1246 to 1249 are connected to a bus 1258 and signal lines whose bandwidth is 8 bps. A bus line 1237 has a bandwidth of 32 bps. Write instruction signals for the buffers are output from the control circuit 1240 via a signal line 1257.

Operations

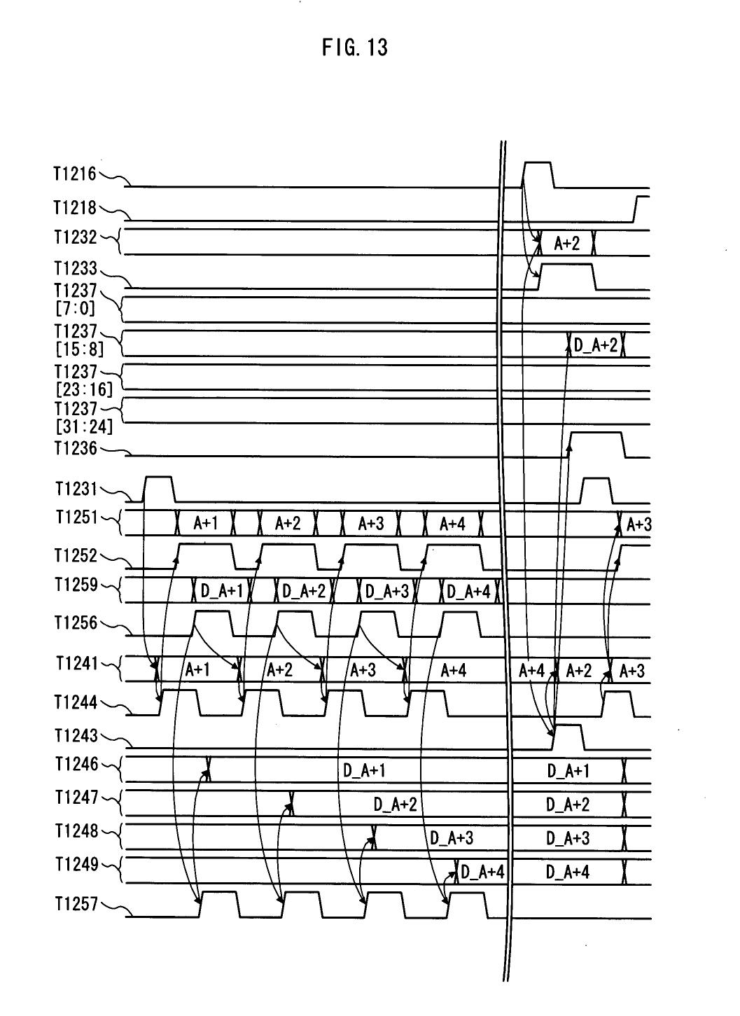

FIG. 13 shows an example of data transitions in the data access system of embodiment 5. The following describes operations performed in embodiment 5 with reference to the timing chart of FIG. 13. Note that in FIG. 13, a signal T1237 [7:0] indicates a data transition via the 0th to 7th bits of the bus line 1237. A signal T1237 [15:8] indicates a data transition via the 8th to 15th bits of the bus line 1237. A signal T1237 [23:16] indicates a data transition via the 16th to 23rd bits of the bus line 1237. A signal T1237 [31:24] indicates a data transition via the 24th to 31st bits of the bus line 1237.

FIG. 13 shows data transitions from when the first instance of data transfer ends. Here, the first instance of data transfer was an access to address A of the storage apparatus 1250.

As shown by a signal T1231, the hold circuit 1230 receives an update signal A_st when the data transfer ends and as shown by a signal T1241, the address buffer 1241 of the hold circuit 1230 holds an address value that has been incremented by one by the increment circuit 1242. As shown by a signal T1251, the address value “A+1” held by the address buffer 1241 is output to the storage apparatus 1250 as the address signal Adr_1. As shown by a signal T1252, the control circuit 1240 outputs the chip select signal CS_1. Although not depicted in FIG. 13, the control circuit 1240 also outputs the read signal r_en_1.

After access preparation has been completed and the access completion signal DK_1 has been output, the control circuit 1240 applies a write signal “write” to the buffer 1246 via the signal line 1257, as shown by a signal T1257. As shown by a signal T1246, the buffer 1246 receives the write signal “write” and stores the data Dat_A+1 corresponding to the address “A+1”.

As shown by a signal T1241, the control circuit 1240 receives the access completion signal DK_1, the increment circuit 1242 increments the address value of the address buffer 1241, and the address buffer 1241 stores the updated address value “A+2”.

After the address value of the address buffer 1241 has been updated to “A+2”, data Dat_A+2 corresponding to the address value “A+2” is stored in the buffer 1247, similarly to when the address value was updated to “A+1”. Thereafter, data is repeatedly stored until the address value of the buffer 1241 reaches “A+4”. As a result, the buffer 1248 of the hold circuit 1230 stores data Dat_A+3 corresponding to an address value “A+3”, and the buffer 1249 stores data Dat_A+4 corresponding to an address value “A+4”.

Thereafter, as shown by a signal T1216, the CPU 1211 applies the read request signal r_req to the BCU 1212 via the signal line 1216. Here, the output address value is the address “A+2” of the storage apparatus 1250.

As shown by a signal T1232, the data A+2 is output via the bus line 1232. Also, as shown by a signal T1233, the chip select signal CS_0 is output via the bus line 1233.

As shown by a signal T1243, the address comparison circuit 1245 receives the address signal Adr_0 indicating the address value “A+2”, and determines that the received address value “A+2” matches the data stored in the buffer 1247. More specifically, the address comparison circuit 1245 compares the address value “A+2” to the address value stored in the address buffer 1241 and three addresses that have been successively decremented. Upon determining that the address values match, the address comparison circuit 1245 outputs the address comparison signal Adr_comp via the signal line 1243.

As shown by a signal T1241, the address buffer 1241 receives the address comparison signal Adr_comp, and updates the stored address value to “A+2”. Also, as shown by a signal T1236, the control circuit 1240 outputs the data strobe signal DS_0 to notify the BCU 1212 that data can be read immediately.

Upon receiving the data strobe signal DS_0, the BCU 1212 continuously applies the chip select signal CS_0 and read signal r_en_0, and reads the data via the 8th to 15th bits of the bus line 1237.

When the data read ends, the hold circuit 1230 causes the buffers 1246 to 1249 to store data corresponding to four address values following the address value “A+2”.

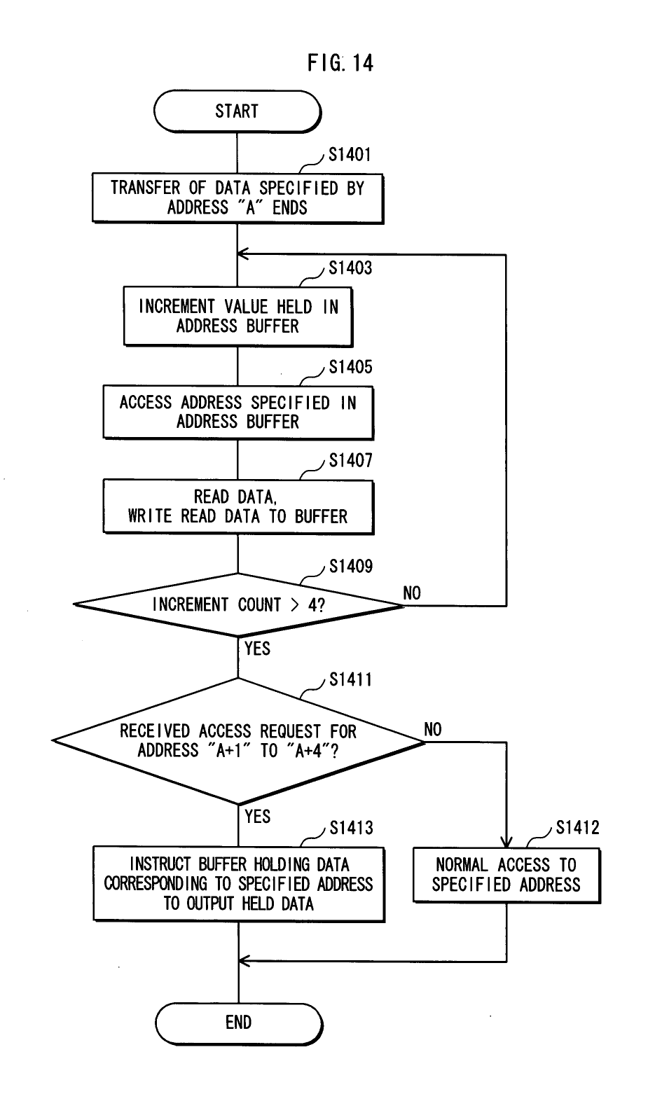

The flowchart of FIG. 14 shows the operations described using the timing chart of FIG. 13, from the viewpoint of operations performed by the hold circuit 1230, which is a characteristic portion of embodiment 5.

First, the transfer of data specified by address A ends (step S1401). The address buffer 1241 then outputs the stored address value to the increment circuit 1242. The increment circuit 1242 increments the received address value by one and outputs the incremented address value to the address buffer 1241. The address buffer 1241 re-stores the received address value (step S1403).

Given that the address value of the address buffer 1241 has been updated, the hold circuit 1230 accesses data in the storage apparatus 1250 at the incremented address (step S1405). Specifically, the address buffer 1241 outputs the address signal Adr_1 to the storage apparatus 1250, and the control circuit 1240 outputs the chip select signal CS_1 and the read signal r_en_1 to the storage apparatus 1250.

Upon completing preparation for the data transfer, the storage apparatus 1250 outputs the access completion signal DK_1. The hold circuit 1230 receives the access completion signal DK_1, and causes the control circuit 1240 to write data corresponding to the incremented address value to one of the buffers 1246 to 1249 that is not storing data (step S1407).

After the data has been written, the address buffer 1241 determines whether incrementing has been performed four times or more (step S1409). Specifically, the address buffer 1241 determines whether the value stored by the address buffer 1241 is greater than the address value of the received data that has been incremented by four.

If incrementing has not been performed four times or more (step S1409:NO), processing returns to step S1403.

If incrementing has been performed four times or more (step S1409:YES), the hold circuit 1230 waits until another access request is received from the BCU 1212.

When another request has been received from the BCU 121, the hold circuit 1230 judges whether the address value indicated by the access request matches any of the address values corresponding to the data stored in the buffers 1246 to 1249 (step S1411). Specifically, the hold circuit 1230 judges whether the address value indicated by the access request matches any of four address values that have been successively incremented from the address value stored in the address buffer 1241. Here, the address value indicated by the access request is compared to the addresses “A+1” to “A+4”.

Upon judging that the address values do not match (step S1411:NO), the hold circuit 1230 performs normal access to the address specified by the access request, that is to say, performs the access shown in FIG. 3 of embodiment 1 (step S1412).

Upon judging that the address values match (step S1411:YES), the hold circuit 1230 outputs the data strobe signal DS_0 indicating that data reading is immediately possible, and outputs the data corresponding to the address value from one of the buffers 1246 to 1249 to the BCU 1212 (step S1413).

Thereafter, processing is again performed from step S1403.

As described above, in the present embodiment, the hold circuit reads a plurality of data pieces in advance in order to immediately enable a data transfer if the address specified by the microcontroller matches an address of where any of the held data pieces was stored in the storage apparatus.

Note that the present embodiment is only effective in a case of reading data.

Supplementary Remarks

Although described based on the above embodiments, a data access system of the present invention is not limited to the above embodiments. The following exemplary variations are also included in the present invention.

(1) Although a data read is performed in the above embodiments, a data write may be performed instead. Similarly to a data read, a case of a data write requires a data write preparation time (access time) in the storage apparatus. This time may be counted or acquired in advance from the storage apparatus. Also, the BCU may apply an address signal to the hold circuit for a predetermined time instead of for the entire access time.

This structure enables the address bus to be freed up more quickly than in conventional technology even in the case of a data write.

(2) The present invention may be data transfer methods described in the above embodiments.

Also the present invention may be a computer program for causing a computer to operate by the methods described in the above embodiments. The computer program may be recorded on various types of recording media typified by, for example, a flexible disk, a hard disk, CD (Compact Disc), DVD (Digital Versatile Disc, BD (Blue-ray Disc), MO (Magneto-Optical) disc, flash memory, or a semiconductor memory.

(3) The functional units described in the above embodiments of the present invention may be constituted by one or a plurality of LSIs (Large Scale Integration) or VLSIs (Very Large Scale Integration). Alternatively a single LSI or VLSI may include a plurality of functions.

(4) Although incrementing is performed four times in accordance with the number of buffers of the hold circuit 1230 in embodiment 4, incrementing may be performed more times as long as there is an equal increase in the number of buffers.

Also, instead of being performed four times, incrementing may be performed five times, which is one time more than the number of buffers (four). In this case, after data has been stored in the buffer 1249, the hold circuit may enable access to an address that has been further incremented by one.

(5) In the processing described in embodiment 5, a new access request is not generated until the address value has been incremented four times. However, a new access request may of course be generated before incrementing has been performed four times. As such, if only two pieces of data have been stored in the buffer when the new access request is received, the address value indicated by the new access request is compared to the address values corresponding to the two pieces of data.

(6) In embodiment 5, the data transfer is performed if there is a match between address values. The following structure may be applied when the hold circuit includes a plurality of buffers such as in embodiment 5.

When a sequence of data pieces at different addresses is to be read, the hold circuit may store the data pieces in the buffers, and the microcontroller may apply a single chip select signal and read signal for data writing. This enables a plurality of data pieces to be read by the application of a signal read signal.

(7) Although data transfers from the two storage apparatuses in embodiment 2 are performed via either the high-order bits or low-order bits of data buses depending on the storage apparatus, a single storage apparatus may transfer two data pieces, one data piece via the high-order bits of a data bus, and the other data piece via the low-order bits of the same data bus.

(8) Although the increment circuit in the above embodiments increments an address value by one, the increment circuit may increment only a predetermined address value.

### INDUSTRIAL APPLICABILITY

A data access system of the present invention can be utilized as a bus controller for efficiently using an address bus when a storage apparatus performs access by a handshake access method.

What is claimed is:

1. A data access system comprising:
an access request circuit operable to output a first access signal that includes address information;
a storage apparatus operable to receive a second access signal and access an internal storage area; and
a hold circuit that is connected to the access request circuit by a plurality of bus lines, each being for transferring a different predetermined signal, that is connected to the storage apparatus by a signal line, and that is operable to receive the first access signal output by the access request circuit, and continuously output the second access signal to the storage apparatus until the access in the storage apparatus has ended, the second access signal indicating content identical to the first access signal, wherein
the access request circuit outputs the first access signal for a predetermined time period that is shorter than from when the first access signal is output to the hold circuit until when the access in the storage apparatus has ended.

2. The data access system of claim 1, wherein
the first access signal further includes information indicating one of a data read request and a data write request,
the storage apparatus includes
a completion signal transmission unit operable to transmit, to the hold circuit, a completion signal indicating that preparation for a data transfer in accordance with the second access signal received from the hold circuit has been completed, and
an input/output unit operable to output read-target data from an address specified by the second access signal, and output write write-target data to the internal storage area indicated by the address,
the hold circuit includes
a completion signal transfer unit operable to transfer the completion signal to the access request circuit, and
a data transfer unit operable to (i) receive the write-target data that has been output by the access request circuit and transfer the received write-target data to the storage apparatus, and (ii) receive the read-target data that has been output by the input/output unit of the storage apparatus and transfer the received read-target data to the access request circuit,
only in a first instance of outputting the first access signal, the access request circuit continuously outputs the first access signal via one of the bus lines that is for transferring the first access signal, until the completion signal has been received from the hold circuit, and
the access request circuit includes
a transmission/reception unit operable to transmit the write-target data via one of the bus lines that is for transferring the write-target data and receive the read-target data via one of the bus lines that is for transferring the read-target data,
a measurement unit operable to measure an access wait time from the first instance of outputting the first access signal to the storage apparatus via the one of the bus lines for transferring the first access signal, until when the completion signal has been received from the hold circuit, and store therein the measured access wait time, and
a control unit operable to, in a second and subsequent instances of applying the first access signal, (i) again apply the first access signal via the one of the bus lines for transferring the first access signal when the access wait time stored in the measure unit has elapsed, the access wait time having begun when a previous instance of applying the first access signal for the predetermined time period has begun, and (ii) cause the transmission/reception unit to one of receive the read-target data and transmit the write-target data.

3. The data access system of claim 1, wherein
the storage apparatus further includes
a wait time storage unit operable to have stored therein a wait time from when the second access signal has been received until when the preparation for the data transfer has been completed, and
a notification unit operable to notify the wait time to the access request circuit via the hold circuit, and
after outputting the first access signal for the predetermined time period and thereafter waiting until the wait time notified by the notification unit has elapsed, the access request circuit again outputs the first access signal to cause execution of the data transfer.

4. The data access system of claim 2, wherein
the hold circuit further includes a data storage unit operable to have stored therein data, and
the hold circuit receives a plurality of the first access signals, each including a different address information piece, reads a plurality of data pieces from the storage apparatus, each data piece being read from an address corresponding to a different one of the received first access signals, stores the plurality of read data pieces in the data storage unit, and outputs the plurality of data pieces in parallel from the data storage unit to the access request circuit via one or more of the bus lines.

5. The data access system of claim 4, wherein
the access request circuit specifies, for each of the data pieces, one of the plurality of bus lines via which the hold circuit is to output the data piece, and
the hold circuit outputs each data piece via the corresponding bus line specified by the access request circuit.

6. The data access system of claim 2, wherein
the hold circuit further includes
a generation unit operable to, after outputting the read-target data from the address specified by the first signal, generate a third access signal that includes new address information indicating a value of the address that has been varied a predetermined value n, n being a natural integer,
an address information storage unit operable to have stored therein the new address information, and
a judgment unit operable to judge whether the new address information stored in the address information storage unit matches address information included in the first access signal that has been output by the access request circuit in a next instance,
the hold circuit outputs the third access signal generated by the generation unit to the storage apparatus, and
if the judgment unit judges affirmatively, the storage apparatus outputs the read-target data from an address corresponding to the new address information to the access request circuit via the hold circuit.

7. The data access system of claim 6, wherein
the hold circuit further includes a storage unit operable to have stored therein the read-target data from the storage apparatus at the address corresponding to the new address information included in the third access signal generated by the generation unit,
the generation unit generates a new third access signal indicating a new address value after the storage unit has stored the read-target data corresponding to the previously generated third access signal, and
if an address specified by a next first access signal that has been output by the access request circuit matches the address where the read-target data stored in the storage unit was stored in the storage apparatus, the data transfer unit immediately transfers the read-target data stored in the storage unit.

8. A data access apparatus that performs memory access with an external storage apparatus by a handshake method, comprising:
an access request circuit operable to output a first access signal that includes address information; and
a hold circuit that is connected to the access request circuit by a plurality of bus lines, each being for transferring a different predetermined signal, that is connected to the storage apparatus by a signal line, and that is operable to receive the first access signal output by the access request circuit, and continuously output a second access signal to the storage apparatus until the access in the storage apparatus has ended, the second access signal indicating content identical to the first access signal, wherein
the access request circuit outputs the first access signal for a predetermined time period that is shorter than from when the first access signal is output to the hold circuit until when the access in the storage apparatus has ended.

9. The data access apparatus of claim 8, wherein
the first access signal further includes information indicating one of a data read request and a data write request,
the hold circuit includes
a completion signal transfer unit operable to receive, from the storage apparatus, a completion signal indicating that the memory access has been completed, and transfer the completion signal to the access request circuit, and
a data transfer unit operable to (i) receive write-target data that has been output by the access request circuit and transfer the received write-target data to the storage apparatus, and (ii) receive read-target data that has been output by the storage apparatus and transfer the received read-target data to the access request circuit,
only in a first instance of outputting the first access signal, the access request circuit continuously outputs the first access signal via one of the bus lines that is for transferring the first access signal, until the completion signal has been received from the hold circuit, regardless of the predetermined time period, and
the access request circuit includes
a transmission/reception unit operable to transmit the write-target data via one of the bus lines that is for transferring the write-target data and receive the read-target data via one of the bus lines that is for transferring the read-target data,
a measurement unit operable to measure an access wait time from the first instance of outputting the first access signal to the storage apparatus via the one of the bus lines for transferring the first access signal, until when the completion signal has been received from the hold circuit, and store therein the measured access wait time, and
a control unit operable to, in a second and subsequent instances of applying the first access signal, (i) again apply the first access signal via the one of the bus lines for transferring the first access signal when the access wait time stored in the measure unit has elapsed, the access wait time having begun when a previous instance of applying the first access signal for the predetermined time period has begun, and (ii) cause the transmission/reception unit to one of receive the read-target data and transmit the write-target data.

10. A data access integrated circuit that has been mounted in a data access apparatus that performs memory access with an external storage apparatus by a handshake scheme, the data access integrated circuit comprising:
an access request circuit operable to output a first access signal that includes address information; and
a hold circuit that is connected to the access request circuit by a plurality of bus lines, each being for transferring a different predetermined signal, that is connected to the storage apparatus by a signal line, and that is operable to receive the first access signal output by the access request circuit, and continuously output a second access signal to the storage apparatus until the access in the storage apparatus has ended, the second access signal indicating content identical to the first access signal, wherein
the access request circuit outputs the first access signal for a predetermined time period that is shorter than from when the first access signal is output to the hold circuit until when the access in the storage apparatus has ended.

11. The data access integrated circuit of claim 10, wherein
the first access signal further includes information indicating one of a data read request and a data write request,
the hold circuit includes
a completion signal transfer unit operable to receive, from the storage apparatus, a completion signal indicating that the memory access has been completed, and transfer the completion signal to the access request circuit, and
a data transfer unit operable to (i) receive write-target data that has been output by the access request circuit and transfer the received write-target data to the storage apparatus, and (ii) receive read-target data that has been output by the storage apparatus and transfer the received read-target data to the access request circuit,
only in a first instance of outputting the first access signal, the access request circuit continuously outputs the first access signal via one of the bus lines that is for transferring the first access signal, until the completion signal has been received from the hold circuit, regardless of the predetermined time period, and
the access request circuit includes
a transmission/reception unit operable to transmit the write-target data via one of the bus lines that is for transferring the write-target data and receive the read-target data via one of the bus lines that is for transferring the read-target data,
a measurement unit operable to measure an access wait time from the first instance of outputting the first access signal to the storage apparatus via the one of the bus lines for transferring the first access signal, until when the completion signal has been received from the hold circuit, and store therein the measured access wait time, and
a control unit operable to, in a second and subsequent instances of applying the first access signal, (i) again apply the first access signal via the one of the bus lines for transferring the first access signal when the access wait time stored in the measure unit has elapsed, the access wait time having begun when a previous instance of applying the first access signal for the predetermined time period has begun, and (ii) cause the transmission/reception unit to one of receive the read-target data and transmit the write-target data.

12. A data access method used in a data access apparatus that performs data access with an external storage apparatus by a handshake scheme, the data access apparatus including an access request circuit and a hold circuit, comprising the steps of:
causing the access request circuit to output a first access signal that includes address information to the hold circuit for a predetermined time period; and
causing the hold circuit that is connected to the access request circuit by a plurality of bus lines, each being for transferring a different predetermined signal, and that is connected to the storage apparatus by a signal line, to receive the first access signal output by the access request circuit, and continuously output a second access signal to the storage apparatus until the data access in the storage apparatus has ended, the second access signal indicating content identical to the first access signal.
